(19) United States
(12) Patent Application Publication
(10) Pub. No.: US 2011/0193825 A1
(43) Pub. Date: Aug. 11, 2011

(54) Electromagnetic Inductive System with Multi-Signals and Processing Method for Multi-Signal

(75) Inventors: Yun-Hsiang Yeh, Miaoli (TW); Yi-Ting Chen, Hsinchu (TW)

(73) Assignee: WALTOP INTERNATIONAL CORPORATION, Taipei (TW)

(21) Appl. No.: 12/831,943

(22) Filed: Jul. 7, 2010

(30) Foreign Application Priority Data
Feb. 8, 2010 (TW) 099103950

(51) Int. Cl. G06F 3/033

(52) U.S. Cl. 345/179

(57) ABSTRACT

The present invention relates to an electromagnetic inductive system with multi-signals and processing method for multi-signals, and particularly relates to an electromagnetic inductive system capable of identifying frequencies with multi-signals and method capable of identifying frequencies by applying processing method for multi-signals. In the electromagnetic inductive system of the present invention, a position calculating circuit and a pressure calculating circuit are integrated into a multi-signals process circuit. Therefore, the elements and the cost of the electromagnetic inductive system are reduced. Furthermore, it is not necessary to calculate the pressure accurately because the processing method for multi-signals is applied for calculating pressure and selecting functions. Therefore, the method for calculating pressure and selecting functions are simplified and improved.

### FIELD OF THE INVENTION

The present invention relates to an electromagnetic inductive system with multi-signals and processing method for multi-signals, and particularly relates to an electromagnetic inductive system capable of identifying frequencies with multi-signals and method capable of identifying frequencies by applying processing method for multi-signals.

### BACKGROUND OF THE INVENTION

Referring to FIG. 1, is a stereoscopic form diagram illustrating the structure of a conventional electromagnetic inductive system 10. The electromagnetic inductive system 10 comprises a tablet 20, an electromagnetic inductive pen 30, a position calculating circuit 40, a pressure calculating circuit 50 and a micro processor 60. There are several antenna loops 22X distributed along X axis and several antenna loops 22Y distributed along Y axis in the tablet 20 for emitting and receiving the electromagnetic signals. The electromagnetic inductive pen 30 has an inductive circuit for receiving and resonating with the electromagnetic signals emitted by tablet 20, and so, the electromagnetic inductive pen 30 can emit the electromagnetic signals and they are received by the antenna loops 22X and several 22Y on the tablet 20.

Before the electromagnetic inductive pen 30 presses on the tablet 20, the inductive circuit has an original resonance frequency. When the antenna loops 22X, 22Y switch on in turn and emit the electromagnetic signals to resonate with the inductive circuit of the electromagnetic inductive pen 30 one by one, the electromagnetic inductive pen 30 emits the electromagnetic signals which have the same frequency as the resonance frequency of the electromagnetic inductive pen 30. And then, tablet 20 collects the electromagnetic signals which are received by each of the antenna loops 22X, 22Y, and they are transmitted to the position calculating circuit 40. After the electromagnetic signals transmitted to the position calculating circuit 40 are amplified by an amplifier 42 in the position calculating circuit 40, the amplified electromagnetic signals are transmitted to a peak detector 44 in the position calculating circuit 40 for detecting the peaks of the electromagnetic signals received by each of the antenna loops 22X, 22Y. The peaks of the electromagnetic signals received by each of the antenna loops 22X, 22Y are the amplitudes of the electromagnetic signals received by each of the antenna loops 22X, 22Y. And then, a digital-to-analog converter 46 in the position calculating circuit 40 converts each of peaks of the electromagnetic signals into digital forms and they are transmitted to the micro processor 60. Because of the inverse proportion of the magnetic field intensity to the square of distance, the micro processor 60 can calculate the coordinate of the position of the electromagnetic inductive pen 30 according to the peaks of the electromagnetic signals received by each of the antenna loops 22X, 22Y.

When the electromagnetic inductive pen 30 presses on the tablet 20, the resonance frequency of the electromagnetic inductive pen 30 is changed. When the tablet 20 switches on the antenna loop, which the electromagnetic inductive pen 30 presses on, to emit the electromagnetic signal, the inductive circuit of the electromagnetic inductive pen 30 resonates with the electromagnetic signal emitted from the tablet 20 for emitting the electromagnetic signal to the tablet 20. The electromagnetic signal emitted from the electromagnetic inductive pen 30 has the same frequency as the changed resonance frequency of the electromagnetic inductive pen 30. After the tablet 20 receives the electromagnetic signal emitted from the electromagnetic inductive pen 30, the electromagnetic signal is transmitted to the pressure calculating circuit 50. And then, the electromagnetic signal transmitted to the pressure calculating circuit 50 is amplified by an amplifier 52 in the pressure calculating circuit 50, and the amplified electromagnetic signal is transmitted to a phase processor 54 in the pressure calculating circuit 50. The electromagnetic signal is converted into square wave by the phase processor 54, and then, the square wave is converted to a digital signal by a digital-to-analog converter 56 in the pressure calculating circuit 50 and the digital signal is transmitted to the micro processor 60 for calculating the frequency of the electromagnetic signal. The processor 60 calculates the pressure, which is applied to the tablet 20 by the electromagnetic inductive pen 30, according to the difference between the frequency of the electromagnetic signal which is emitted before the electromagnetic pen 30 presses on the tablet 20 and the frequency of the electromagnetic signal which is emitted after the electromagnetic pen 30 presses on the tablet 20.

However, as above-mentioned structure and operation of the conventional electromagnetic inductive system, the conventional electromagnetic inductive system needs both of the position calculating circuit and the pressure calculating circuit for calculating the coordinate of position of the electromagnetic inductive pen and the pressure which is applied to the tablet by the electromagnetic inductive pen. Therefore, the elements of the conventional electromagnetic inductive system can not be reduced and the structure of the conventional electromagnetic inductive system can not be simplified, either. It results that the manufacturing process of the conventional electromagnetic inductive system can not be simplified and the cost of the conventional electromagnetic inductive system can not be reduced. Furthermore, the pressure calculation of the conventional electromagnetic inductive system is complicated and time-consuming because it has a need to calculate the frequency of the electromagnetic signal emitted from the electromagnetic inductive pen more precisely and accurately. Therefore, the work efficiency of the conventional electromagnetic inductive system can not be improved.

Therefore, in view of foregoing drawbacks of conventional electromagnetic inductive system, there is a need to provide an electromagnetic inductive system with multi-signals and processing method for multi-signals without an independent circuit for calculating pressure. Accordingly, the structure of the electromagnetic inductive system with multi-signals is simplified and the cost is reduced. Furthermore, the frequencies of the electromagnetic signals emitted from the electromagnetic inductive pen can be identified more quickly for improving the work efficiency of the electromagnetic inductive system.

### SUMMARY OF THE INVENTION

An objective of this invention is to provide an electromagnetic inductive system with multi-signals wherein a processing method for multi-signals is applied to identify frequencies and a position calculating circuit and a pressure calculating circuit are integrated into one circuit. Therefore, the electromagnetic inductive system has no need of an independent circuit for calculating pressure and the structure of the electromagnetic inductive system is simplified and the cost of the electromagnetic inductive system is reduced.

Another objective of this invention is to provide a processing method for multi-signals, which is capable of identifying frequencies of the electromagnetic signals and gauging the resonance frequency variation for pressure calculation or function selection by several electromagnetic signals with different frequencies. Therefore, there is no need to precisely calculate the real frequencies of the electromagnetic signals. By this method, the difficulty and the complication of pressure calculation are reduced and the process for identifying frequencies and frequency variation is shortened.

According to above mentioned objective, an electromagnetic inductive system with multi-signals is disclosed in this invention. The electromagnetic inductive system with multi-signals comprises an electromagnetic inductive circuit, a pointing device, and a multi-signals processing circuit. The electromagnetic inductive circuit is constructed by several antenna loops for emitting and receiving electromagnetic signals, which are capable of emitting and receiving the electromagnetic signals having different frequencies. The pointing device is used for receiving and inducing the electromagnetic signals emitted from the electromagnetic inductive circuit and for emitting electromagnetic signals to the electromagnetic inductive circuit. The multi-signals processing circuit is used for processing the electromagnetic signals emitted from the pointing device to the electromagnetic inductive circuit and for identifying resonance frequencies of the electromagnetic signals emitted from the pointing device or gauging and monitoring the frequency variation of the electromagnetic signals emitted from the pointing device. The electromagnetic inductive system with multi-signals calculates the coordinate of the position of the pointing device and the pressure which the pointing device applied to the electromagnetic inductive system by the same circuit. This circuit is the multi-signals processing circuit. Therefore, the structure of the electromagnetic inductive system is simplified and the cost is reduced because many elements are omitted.

According to above mentioned objective, a processing method for multi-signals is disclosed in this invention. This method is applied to identify frequencies and comprises steps as following: First, several different electromagnetic signals with different frequencies are emitted by an electromagnetic inductive circuit, and then, the electromagnetic signals are induced by a pointing device. The pointing device induces each of the electromagnetic signals emitted from the electromagnetic inductive circuit in order for emitting the electromagnetic signals with the same frequencies as the frequencies of the electromagnetic signals emitted from the electromagnetic inductive circuit. After, each of the electromagnetic signals emitted from the pointing device is received by the electromagnetic inductive circuit. And then, each of the amplitudes of the electromagnetic signals emitted from the pointing device is detected. After, the resonance frequency variation of the pointing device is calculated or the frequencies of the electromagnetic signals emitted from the pointing device are identified according to the amplitudes of the electromagnetic signals emitted from the pointing device. In this processing method for multi-signals, the amplitudes of the electromagnetic signals with different frequencies are detected for creating a comparison table for frequencies and amplitudes. The frequencies of the electromagnetic signals are identified and the resonance frequency variation of the pointing device is gauged by calculating and comparing with the comparison table. Therefore, this method can be applied to the pressure calculation, function selection or function identification but it has no need to precisely calculating real frequencies of the electromagnetic signals. Accordingly, the difficulty and complication of this method are reduced and the processes for identifying frequencies and gauging the frequency variation are shortened.

Therefore, the effect achieved with the present invention is to provide an electromagnetic inductive system with multi-signals and processing method for multi-signals wherein the position calculating circuit and the pressure calculating circuit are integrated into the same circuit to reduce the elements for simplifying the structure of the electromagnetic inductive system and for reducing the cost of the electromagnetic inductive system. The processing method for multi-signals is applied to the pressure calculation or function selection or function identification without the need of precisely calculating real frequencies of the electromagnetic signals. Accordingly, the difficulty and complication of this method are reduced and the processes for identifying frequencies and gauging the frequency variation are shortened.

### BRIEF DESCRIPTION OF THE DRAWINGS

FIG. 1 is a stereoscopic form diagram illustrating the structure of a conventional electromagnetic inductive system.

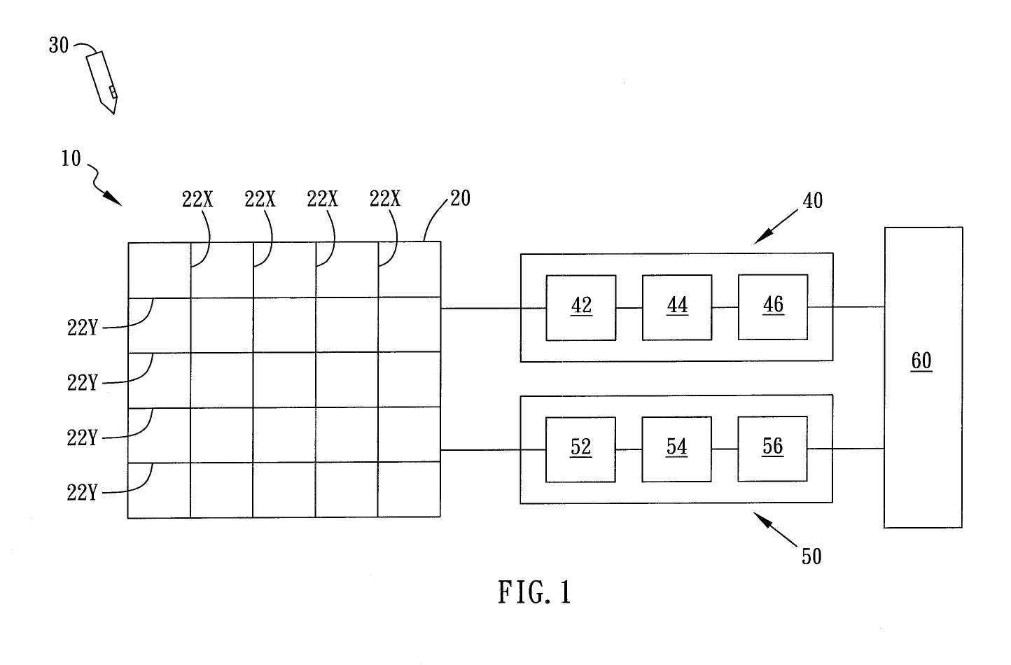

FIG. 2 is a stereoscopic form diagram illustrating the structure of an electromagnetic inductive system with multi-signals in accordance with one embodiment of the present invention.

FIG. 3 is a block diagram illustrating a processing method for multi-signals in accordance with one embodiment of the present invention.

### DESCRIPTION OF THE EXEMPLARY EMBODIMENTS

Although the present invention will be described in accordance with the embodiments shown above, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

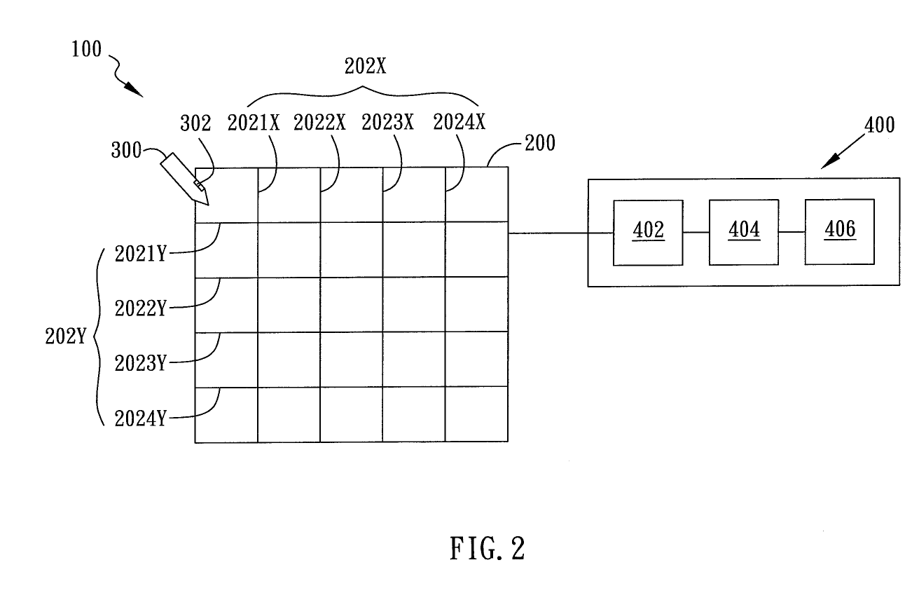

Referring to FIG. 2, it is stereoscopic form diagram illustrating the structure of an electromagnetic inductive system with multi-signals 100 in accordance with one embodiment of the present invention. The electromagnetic inductive system with multi-signals 100 comprises an electromagnetic inductive circuit 200, a pointing device 300, and a multi-signals processing circuit 400. The electromagnetic inductive circuit 200 is constructed by one or several antenna loops for emitting and receiving electromagnetic signals, which are capable of emitting and receiving the electromagnetic signals having different frequencies. The electromagnetic inductive circuit 200 emits at least one first signal and one second signal, and the first signal and the second signal have different frequencies. It means that the electromagnetic inductive circuit 200 emits at least two different electromagnetic signals. The first signal has a first frequency X+Z and the second frequency has a second frequency X−Z. The electromagnetic inductive circuit 200 is constructed by the antenna loops 2021X, 2022X, 2023X, 2024X distributed along X axis and the antenna loops 2021Y, 2022Y, 2023Y, 2024Y distributed along Y axis. They are arranged with equal distance for forming a net. FIG. 2 is a simplified diagram of the structure of the electromagnetic inductive system with multi-signals 100. Therefore, the layout for the antenna loops 202X and 202Y is a simplified layout for the antenna loops of electromagnetic inductive circuit 200, but not limited. In this invention, any type of the antenna loops can be adopted to be the layout for the antenna loops of electromagnetic inductive circuit 200.

The pointing device 300 has an inductive circuit for receiving the electromagnetic signals with different frequencies emitted from the electromagnetic inductive circuit 200 in order and for inducing the electromagnetic signals emitted from the electromagnetic inductive circuit 200 to emit electromagnetic signals to the electromagnetic inductive circuit 200. Besides, the pointing device 300 has a first resonance frequency X to be the original resonance frequency of the pointing device 300. The first resonance frequency X can be converted into a second resonance frequency X+Y by pressing the pointing device 300 (applying the pressure to the electromagnetic inductive system 100 by the pointing device), function selection or using another pointing device. In this situation, the pointing device 300 respectively resonates with the first signal and the second signal by the second resonance frequency X+Y, and then, the pointing device 300 respectively emits a third signal, which has the first frequency X+Z and a first amplitude, and a fourth signal, which has the second frequency X−Z and a second amplitude. X is the resonance frequency of the pointing device 300, and Y is the variation (or difference) between the first resonance frequency and the second resonance frequency. Z is the variation (or difference) between the first resonance frequency and the frequency of first signal, between the first resonance frequency and the frequency of second signal, between the first resonance frequency and the frequency of third signal, and between the first resonance frequency and the frequency of fourth signal.

The multi-signals processing circuit 400 is used for processing the electromagnetic signals emitted from the pointing device 300 to the electromagnetic inductive circuit 200 and for identifying resonance frequencies of the pointing device 300 or gauging and monitoring resonance frequency variation of the pointing device 300. The multi-signals processing circuit 400 comprises a signal amplifying unit 402, a digital-to-analog converter unit 404 and a calculating and processing unit 406.

The signal amplifying unit 402 is connected with the electromagnetic inductive circuit 200 to amplify the electromagnetic signals receiving by the electromagnetic inductive circuit 200 for following process. The digital-to-analog converter unit 404 converts the forms of the electromagnetic signals amplified by the signal amplifying unit 402 to be digital forms, and then, the converted electromagnetic signals are transmitted to calculating and processing unit 406. The calculating and processing unit 406 processes and calculates the electromagnetic signals, which are received by the electromagnetic inductive circuit 200 and are amplified and converted respectively by the signal amplifying unit 402 and the digital-to-analog converter unit, to calculate the coordinates of the position of the pointing device 300 on the electromagnetic inductive system 100 and to identify the present resonance frequency of the pointing device 300 or gauge the resonance frequency variation for pressure calculation or function selection.

The multi-signals processing circuit 400 further comprises a rectifying unit (not showed) between the electromagnetic inductive circuit 200 and the signal amplifying unit 402 for rectifying the electromagnetic signals received by the electromagnetic inductive circuit 200 and transmitting the received electromagnetic signals to the signal amplifying unit 402. Furthermore, the multi-signals processing circuit 400 further comprises a peak detecting unit (not showed) for detecting each of peaks of the electromagnetic signals received by the electromagnetic inductive circuit 200. The peaks of the electromagnetic signals received by the electromagnetic inductive circuit 200 are the amplitudes of the electromagnetic signals received by the electromagnetic inductive circuit 200. For example, after the third signal and the fourth signal are received, rectified and amplified respectively by the electromagnetic inductive circuit 200, the rectifying unit and the signal amplifying unit 402, the peak detecting unit detects the third signal and the fourth signal for respectively detecting the first amplitude of the third signal and the second amplitude of the fourth signal. And then, the the first amplitude and the second amplitude are transmitted to digital-to-analog converter unit 404 to be converted into digital form. After, they are transmitted to the calculating and processing unit 406 for processing and calculating.

The work process of the electromagnetic inductive system 100 for calculating coordinates of the position of the pointing device 300 is described as following: When the pointing device 300 is put on the electromagnetic inductive system 100, the antenna loops 2021X-2024X and 2021Y-2024Y in the electromagnetic inductive circuit 200 are switched on in order for emitting the electromagnetic signals. After the pointing device 300 receives the electromagnetic signals emitted from the electromagnetic inductive circuit 200, the pointing device 300 resonates with the received electromagnetic signals for emitting the electromagnetic signals back to the electromagnetic inductive circuit 200. And then, the antenna loops 2021X-2024X and 2021Y-2024Y receive the electromagnetic signals emitted from the pointing device and the electromagnetic signals are collected to transmit to the multi-signals processing circuit 400. After these electromagnetic signals are amplified by the signal amplifying unit 402 and converted into digital form by the digital-to-analog converter unit 404, the intensity of the electromagnetic signals received by the antenna loops 2021X-2024X and 2021Y-2024Y is got and transmitted to the calculating and processing unit 406. Following the principle that the inverse proportion of the magnetic field intensity to the square of distance, the calculating and processing unit 406 calculates the coordinates of the position of the pointing device 300 on the electromagnetic inductive system 100 according to the intensity (amplitudes or peaks) of the electromagnetic signals received by each of the antenna loops 2021X-2024X and 2021Y-2024Y.

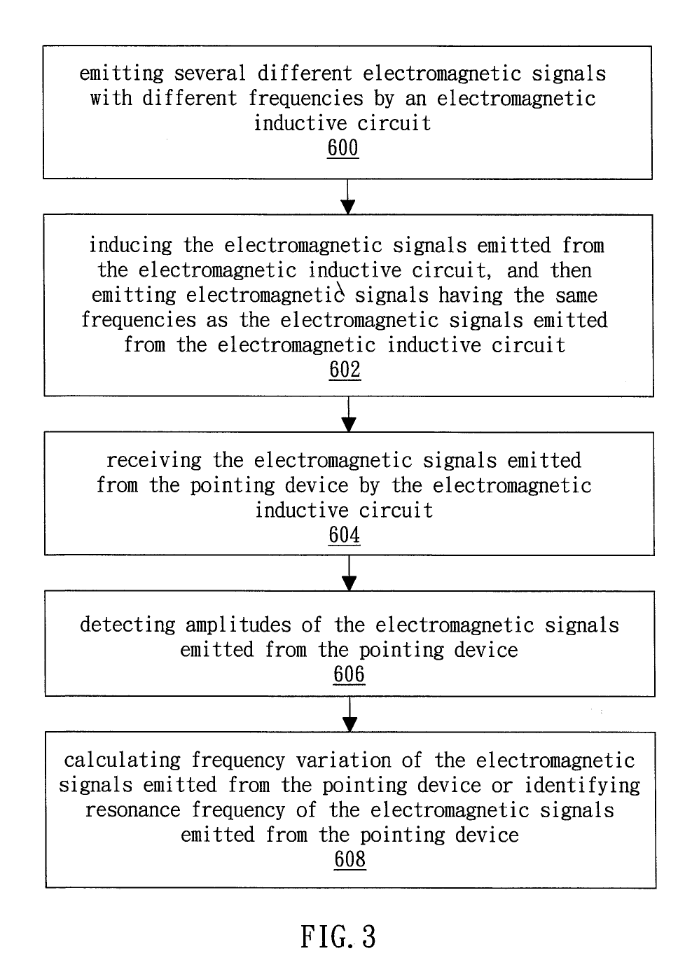

Besides, in the electromagnetic inductive system 100, the processing method for multi-signals is applied by the multi-signals processing circuit 400 for frequency identification and for gauging and monitoring frequency variation. By this method, the pressure which the pointing device 300 exerts on or applies to the electromagnetic inductive system 100 is calculated or the function selection is performed. FIG. 3 is a block diagram illustrating a processing method for multi-signals in accordance with one embodiment of the present invention. Referring to both of FIGS. 2 and 3, the processing method for multi-signals of this invention and the work process illustrated how the electromagnetic inductive system 100 identifies frequencies and gauges frequency variation are described as following:

After the electromagnetic inductive system 100 calculates and gets the coordinate of the position of the pointing device 300 by above mentioned method for calculating the position of the pointing device 300, the original resonance frequency (the first resonance frequency X) of the pointing device 300 is converted into the second resonance frequency X+Y because of the actions, for example pressing the pointing device 300 on the electromagnetic inductive system 100 (or exerting pressure on the electromagnetic inductive system 100 by the pointing device 300), pressing the button 302 on the pointing device 300 and using anther pointing device having different frequency. Therefore, a step for converting the resonance frequency of the pointing device 300 is performed.

The antenna loops in the electromagnetic inductive circuit 200 and under the position of the pointing device 300, for example the antenna loops 2021X and 2021Y are under the position of the pointing device 300 in FIG. 2, emit the electromagnetic signals having different frequencies in order (step 600). The electromagnetic signals emitted from electromagnetic inductive circuit 200 comprise at least two or more electromagnetic signals having different frequencies. It means that the electromagnetic signals emitted from electromagnetic inductive circuit 200 comprise at least one first signal having the first frequency X+Z and at least one second signal having the second frequency X−Z.

After, the pointing device 300 induces the first signal and the second signal emitted from electromagnetic inductive circuit 200, and the second resonance frequency X+Y resonates with the first signal and the second signal for emitting a third signal which has first frequency X+Z and a first amplitude and a fourth signal which has the second frequency X−Z and a second amplitude (step 602). The third signal and the first signal have the same frequency, and the fourth signal and the second signal have the same frequency. According to the principle of resonance, more similar the two frequencies are, more powerful the resonance between the two frequencies is. Therefore, no matter the third signal or the fourth signal, the signal having more similar frequency as the second resonance frequency will have larger amplitude.

When both of Y and Z are positive number, the first frequency X+Z is more similar to the second resonance frequency X+Y than the second frequency X−Z. Therefore, the first amplitude is larger than the second amplitude. On the contrary, when both of Y and Z are negative number, the second frequency X−Z is more similar to the second resonance frequency X+Y than the first frequency X+Z. Therefore, the second amplitude is larger than the first amplitude. When one of Y and Z is positive number and the other is negative number, the second frequency X−Z is more similar to the second resonance frequency X+Y than the first frequency X+Z. Therefore, the second amplitude is larger than the first amplitude.

After, the third signal and the fourth signal emitted from the pointing device 300 are received by the electromagnetic inductive circuit 200 in order (step 604), and then, they are transmitted to multi-signals processing circuit 400. After the third signal and the fourth signal are amplified by the signal amplifying unit 402, the amplitudes of the electromagnetic signals (the third signal and the fourth signal) emitted from the pointing device 300 are detected (step 606). It means that the amplitudes of the third signal and the fourth signal are detected by the multi-signals processing circuit 400. In this step of detecting the amplitudes of the third signal and the fourth signal, the amplitude (the first amplitude) of the third signal and the amplitude (the second amplitude) of the fourth signal are detected by a peak detecting unit and they are transmitted to the digital-to-analog converter unit 404. And then, the digital-to-analog converter unit 404 converts the third signal and the fourth signal into digital forms and transmitted to the calculating and processing unit 406.

After, the calculating and processing unit 406 calculates the resonance frequency variation of the pointing device 300 or identifies the present resonance frequency of the pointing device 300 according to the first amplitude of the third signal and the second amplitude of the fourth signal detected by a peak detecting unit (step 608). In this step, the ratio of the first amplitude to the second amplitude (or the second amplitude to the first amplitude), difference (or variation) between the first amplitude and the second amplitude, or the sum of the first amplitude and the second amplitude is calculated. Therefore, the resonance frequency or the resonance frequency variation of the pointing device and a comparison table are gotten. The comparison table is a table which lists the ratio, the difference and the sum between the first amplitude and the second amplitude. Therefore, it is easy to identify the resonance frequency of the pointing device 300 and to gauge the resonance frequency variation of the pointing device 300 by the electromagnetic inductive system 100 and by applying the processing method for multi-signals of this invention.

The amplitudes of the third signal and the fourth signal are decided respectively by the intensity of the resonance between the frequency of the third signal (the first frequency X+Z) and the resonance frequency (the second resonance frequency X+Y) of the pointing device 300 and by the intensity of the resonance between the frequency of the fourth signal (the second frequency X−Z) and the resonance frequency (the second resonance frequency X+Y). Therefore, each of the resonance frequencies or the resonance frequency variations of the pointing device 300 results in changes of the first amplitude of the third signal and the second amplitude of the fourth signal. Because the different resonance frequencies or the different resonance frequency variations of the pointing device 300 results in different changes of the first amplitude of the third signal and different changes of the second amplitude of the fourth signal, a comparison table is created according to the ratio (or proportion) the first amplitude to the second amplitude (or the second amplitude to the first amplitude), the difference between the first amplitude and the second amplitude, and the sum of the first amplitude and the second amplitude. Therefore, the resonance frequency and the resonance frequency variation of the pointing device 300 can be known by comparing with this comparison table for identifying frequencies and gauging the frequency variation.

Take Table 1 as example, the electromagnetic inductive circuit respectively emits the first signal having the first frequency X+Z and the second signal having second frequency X−Z. When the resonance frequency of the pointing device 300 is X, the pointing device 300 emits third signal having the first frequency X+Z and the fourth signal having second frequency X−Z. The third signal and the fourth signal has the same amplitudes because both of the difference between the frequency of the third signal and the resonance frequency X and the difference between the frequency of the fourth signal and the resonance frequency X are Z. As Table 1 showing, both of the first amplitude and the second amplitude are 1V. Therefore, the ratio of the first amplitude to the second amplitude is 1, and the difference between the first amplitude and the second amplitude is zero and the sum of the first amplitude and the second amplitude is 2.

When the second resonance frequency of the pointing device 300 is X+Z, the amplitude of the third signal is larger than the amplitude of the fourth signal because the frequency of the third signal is the same with the second resonance frequency X+Z and the difference between the frequency of the fourth signal and the resonance frequency X+Z is 2Z KHz. It means that the first amplitude is larger than the second amplitude in this situation. In this situation as Table 1 showing, the first amplitude is 2V and the second amplitude is 1V. Therefore, the ratio of the first amplitude to the second amplitude is 2, and the difference between the first amplitude and the second amplitude is 1 and the sum of the first amplitude and the second amplitude is 3. When the second resonance frequency of the pointing device 300 is X−Z, the amplitude of the fourth signal is larger than the amplitude of the third signal because the frequency of the fourth signal is the same with the second resonance frequency X−Z and the difference between the frequency of the third signal and the resonance frequency X−Z is 2Z KHz. It means that the second amplitude is larger than the first amplitude in this situation. In this situation as Table 1 showing, the first amplitude is 1V and the second amplitude is 2V. Therefore, the ratio of the first amplitude to the second amplitude is 1/2, and the difference between the first amplitude and the second amplitude is 1 and the sum of the first amplitude and the second amplitude is 3.

Therefore, a comparison table as Table 2 or a linear formula or a non-linear formula can be created according to the ratio of the first amplitude to the second amplitude, the difference between the first amplitude and the second amplitude and the sum of the first amplitude and the second amplitude for identifying the resonance frequencies of the pointing device without the need to precisely calculating the real resonance frequency of the pointing device. For example, according to Table 2, after the third signal and the fourth signal received by the electromagnetic inductive circuit 200 are processing and calculating by the multi-signals processing circuit 400, the electromagnetic inductive system 100 gets the information that the ratio of the amplitude of the third signal (the first amplitude) to the amplitude of the fourth signal (the second amplitude) is 2, and the difference between the first amplitude and the second amplitude is 1 and the sum of the first amplitude and the second amplitude is 3. Therefore, the electromagnetic inductive system 100 knows that the present resonance frequency of the pointing device is X+Z (KHz) and the difference (or variation) Y between the present resonance frequency (the second resonance frequency X+Y) and the original resonance frequency (the first resonance frequency X) is Z after the electromagnetic inductive system 100 searches or contrast with the comparison table according to these information. Therefore, it has no need to precisely calculate the present resonance frequency of the pointing device and the processes for identifying frequencies and gauging frequency variation still can be finished without calculating the present resonance frequency precisely. The complicated and difficult process for frequency calculation is omitted and the processes for identifying frequencies and gauging frequency variation are simplified by this method.

TABLE 2

| The resonance | | The ratio of the | The difference | The sum of the |
|---|---|---|---|---|
| frequency of | | first amplitude | between the first | first amplitude |
| the pointing | | to the second | amplitude and the | and the second |
| device | | amplitude | second amplitude | amplitude |
| X | KHz | 1 | 0 | 2 |
| X + Z | KHz | 2 | 1 | 3 |
| X − Z | KHz | 1/2 | 1 | 3 |

Of course, the present resonance frequency (the second resonance frequency X+Y) of the pointing device can be calculated and found by the comparison table according to only one of the ratio of the first amplitude to the second amplitude, the difference between the first amplitude and the second amplitude, and the sum of the first amplitude and the second amplitude, or according to two of them, or according to all of them.

Therefore, the electromagnetic inductive system with multi-signals adopts above mentioned processing method for multi-signals for identifying the resonance frequency of the pointing device or for gauging the resonance frequency variation of the pointing device. Furthermore, the resonance frequency of the pointing device is changed with the change of the pressure which the pointing device exerts on the electromagnetic inductive system. Therefore, when the resonance frequency of the pointing device is changed with pressure (converting the first resonance frequency into the second resonance frequency), the resonance frequency of the pointing device is identified or the resonance frequency variation of the pointing device is gauged according to the ratio of the first amplitude to the second amplitude, the difference between the first amplitude and the second amplitude, and the sum of the first amplitude and the second amplitude by this processing method for multi-signals. Accordingly, the present resonance frequency of the pointing device is got by the comparison table, and the pressure, which the pointing device exerts on the electromagnetic inductive system, is calculated or found by the comparison table according to the relationship between the resonance frequency and the pressure.

Similarly, the function selection of the pointing device, for example writing, erasing and etc., is performed by using this processing method for multi-signals to identify the resonance frequency of the pointing device or to gauge the resonance frequency variation of the pointing device. The different pointing devices, for example a electromagnetic inductive pen, a electromagnetic eraser or the pointing devices representing different colors, is also identified by using this processing method for multi-signals to identify the resonance frequency of the pointing device or to gauge the resonance frequency variation of the pointing device. Most of the common electromagnetic inductive systems apply different resonance frequencies to represent different functions of the pointing device, or to represent different pointing devices with different functions.

Therefore, when the resonance frequency of the pointing device is changed or varied (the first resonance frequency is converted into the second resonance frequency) because the function selection is performed, for example a button of the pointing device is pressed for changing the resonance frequency of the pointing device, or when the resonance frequency of the pointing device is changed or varied because another pointing device with different frequency is used, the electromagnetic inductive system identifies the resonance frequency of the pointing device or gauges the resonance frequency variation according to the ratio of the first amplitude to the second amplitude, the difference between the first amplitude and the second amplitude, and the sum of the first amplitude and the second amplitude by above mentioned processing method for multi-signals. Accordingly, the present resonance frequency of the pointing device is got by searching the comparison table with these information (the ratio, the difference and the sum), and one of the functions of the pointing device is directly selected or one of the pointing devices is identified because each of the resonance frequencies correspond to different functions of a pointing device or to different pointing devices having different functions.

Furthermore, because the electromagnetic inductive system applied the above mentioned process method for multi-signals, the electromagnetic inductive system uses the amplitudes of the electromagnetic signals to calculate the coordinates of the position of the pointing device and the pressure which the pointing device exerts on the electromagnetic inductive system or is applied to press the pointing device. It has no need to precisely calculate the real frequencies of the electromagnetic signals or the real resonance frequencies of the pointing device. Therefore, except a position calculating circuit, the electromagnetic inductive system of this invention needn't add an independent pressure calculating circuit for pressure calculation as the conventional electromagnetic inductive system. The electromagnetic inductive system of this invention has a multi-signals processing circuit instead of both of the position calculating circuit and the pressure calculating circuit, and both of the coordinates of the position of the pointing device and the pressure which the pointing device exerts on the electromagnetic inductive system or is applied to press the pointing device are directly calculated by this multi-signals processing circuit. Therefore, the electromagnetic inductive system with multi-signals of this invention has less elements than the conventional electromagnetic inductive system and the cost of the electromagnetic inductive system with multi-signals of this invention is reduced because of less elements.

Therefore, the present invention provides an electromagnetic inductive system with multi-signals and processing method for multi-signals wherein the position calculating circuit and the pressure calculating circuit are integrated into the same circuit to reduce the elements for simplifying the structure of the electromagnetic inductive system and reducing the cost of the electromagnetic inductive system. The processing method for multi-signals is applied to the pressure calculation or function selection or function identification without the need of precisely calculating real frequencies of the electromagnetic signals. Accordingly, the difficulty and complication of this method are reduced and the processes for identifying frequencies and gauging the frequency variation are shortened.

What is claimed is:

1. An electromagnetic inductive system with multi-signals, comprising:
an electromagnetic inductive circuit wherein said electromagnetic inductive circuit can emit several electromagnetic signals with different frequencies and can receive electromagnetic signals;
a pointing device for inducing said electromagnetic signals emitted from said electromagnetic inductive circuit and for emitting electromagnetic signals to said electromagnetic inductive circuit; and
a multi-signals processing circuit for processing the electromagnetic signals emitted from said pointing device and for identifying resonance frequencies of said electromagnetic signals emitted from said pointing device or gauging frequency variation of said electromagnetic signals emitted from said pointing device.

2. The electromagnetic inductive system with multi-signals of claim 1, wherein said multi-signals processing circuit comprises, comprising:
a signal amplifying unit for amplifying the electromagnetic signals receiving by said electromagnetic inductive circuit;
a digital-to-analog converter unit for converting the forms of the electromagnetic signals to be digital forms; and
a calculating and processing unit for calculating and processing the electromagnetic signals received by said electromagnetic inductive circuit in order to find the position of said pointing device and to identify resonance frequencies of said electromagnetic signals emitted from said pointing device or gauge frequency variation of said electromagnetic signals emitted from said pointing device.

3. The electromagnetic inductive system with multi-signals of claim 2, wherein said multi-signals processing circuit further comprises a rectifying unit for rectifying the electromagnetic signals received by said electromagnetic inductive circuit.

4. The electromagnetic inductive system with multi-signals of claim 2, wherein said multi-signals processing circuit further comprises a peak detecting unit for detecting the peaks of the electromagnetic signals received by said electromagnetic inductive circuit.

5. The electromagnetic inductive system with multi-signals of claim 2, wherein said electromagnetic inductive circuit emits at least two different electromagnetic signals which have different frequencies, and said at least two different electromagnetic signals comprise a first signal with first frequency and a second signal with second frequency.

6. The electromagnetic inductive system with multi-signals of claim 5, wherein said pointing device has a first resonance frequency to be the original resonance frequency of said pointing device.

7. The electromagnetic inductive system with multi-signals of claim 6, wherein said first resonance frequency can be converted into a second resonance frequency by pressing said pointing device, function selection or using another pointing device.

8. The electromagnetic inductive system with multi-signals of claim 7, wherein said first signal and said second signal respectively resonate with said first resonance frequency, and then, said pointing device emits a third signal and a fourth signal for being receiving by said electromagnetic inductive circuit.

9. The electromagnetic inductive system with multi-signals of claim 8, wherein said third signal has said first frequency and a first amplitude, and said fourth signal has said second frequency and a second amplitude.

10. The electromagnetic inductive system with multi-signals of claim 9, wherein said multi-signals processing circuit respectively detects said first amplitude and said second amplitude, and calculates a ratio of said first amplitude to said second amplitude or said second amplitude to said first amplitude, difference between said first amplitude and said second amplitude, or sum of said first amplitude and said second amplitude for gauging the frequency variation of said electromagnetic signals emitted from said pointing device or for identifying resonance frequency of said electromagnetic signals emitted from said pointing device.

11. The electromagnetic inductive system with multi-signals of claim 10, wherein when said first resonance frequency is converted into said second resonance frequency by pressing said pointing device, pressure applied to press said pointing device can be gotten by gauging the frequency variation of said electromagnetic signals emitted from said pointing device or by identifying resonance frequency of said electromagnetic signals emitted from said pointing device.

12. The electromagnetic inductive system with multi-signals of claim 10, wherein when said first resonance frequency is converted into said second resonance frequency by function selection, a function selected by said pointing device can be identified by gauging the frequency variation of said electromagnetic signals emitted from said pointing device or by identifying resonance frequency of said electromagnetic signals emitted from said pointing device.

13. The electromagnetic inductive system with multi-signals of claim 10, wherein when said first resonance frequency is converted into said second resonance frequency by using another pointing device, electromagnetic inductive system with multi-signals can identify the function, which said another pointing device stands for, by gauging the frequency variation of said electromagnetic signals emitted from said pointing device or by identifying resonance frequency of said electromagnetic signals emitted from said pointing device.

14. The processing method for multi-signals, comprising:
emitting several different electromagnetic signals with different frequencies by an electromagnetic inductive circuit;
inducing the electromagnetic signals emitted form said electromagnetic inductive circuit by a pointing device, and then, emitting electromagnetic signals by said pointing device wherein said electromagnetic signals emitted form said pointing device and said electromagnetic signals emitted form said electromagnetic inductive circuit have the same frequencies;
receiving the electromagnetic signals emitted from said pointing device by said electromagnetic inductive circuit;
detecting amplitudes of the electromagnetic signals emitted from said pointing device; and
calculating frequency variation of said electromagnetic signals emitted from said pointing device or identifying resonance frequency of said electromagnetic signals emitted from said pointing device.

15. The processing method for multi-signals of claim 14, wherein at least two different electromagnetic signals with different frequencies are emitted at said step of emitting several different electromagnetic signals with different frequencies by an electromagnetic inductive circuit, and said at least two different electromagnetic signals comprises a first signal with first frequency and a second signal with second frequency.

16. The processing method for multi-signals of claim 15, wherein said pointing device has a first resonance frequency to be the original resonance frequency of said pointing device.

17. The processing method for multi-signals of claim 16, further comprising a step of converting resonance frequency of said pointing device wherein said first resonance frequency is converted into a second resonance frequency by pressing said pointing device, function selection or using another pointing device.

18. The processing method for multi-signals of claim 17, wherein said step of inducing the electromagnetic signals emitted form said electromagnetic inductive circuit by a pointing device is performed by said second resonance frequency respectively resonating with said first signal and said second signal for emitting a third signal and a fourth signal.

19. The processing method for multi-signals of claim 18, wherein said third signal has said first frequency and a first amplitude, and said fourth signal has said second frequency and a second amplitude.

20. The processing method for multi-signals of claim 19, wherein said step of detecting amplitudes of the electromagnetic signals emitted from said pointing device is performed by detecting values of said first amplitude and said second amplitude.

21. The processing method for multi-signals of claim 20, wherein said step of calculating change of said electromagnetic signals emitted from said pointing device or identifying resonance frequency of said electromagnetic signals emitted from said pointing device is performed by calculating a ratio of said first amplitude to said second amplitude or said second amplitude to said first amplitude, difference between said first amplitude and said second amplitude, or sum of said first amplitude and said second amplitude for gauging the frequency variation of said electromagnetic signals emitted from said pointing device or for identifying resonance frequency of said electromagnetic signals emitted from said pointing device.

22. The processing method for multi-signals of claim 21, wherein when said first resonance frequency is converted into said second resonance frequency by pressing said pointing device, a value of a pressure applied to press said pointing device can be gotten by gauging the frequency variation of said electromagnetic signals emitted from said pointing device or by identifying resonance frequency of said electromagnetic signals emitted from said pointing device.

23. The processing method for multi-signals system of claim 21, wherein when said first resonance frequency is converted into said second resonance frequency by function selection, a function selected by said pointing device can be identified by gauging the frequency variation of said electromagnetic signals emitted from said pointing device or by identifying resonance frequency of said electromagnetic signals emitted from said pointing device.

24. The processing method for multi-signals system of claim 21, wherein when said first resonance frequency is converted into said second resonance frequency by using another pointing device, electromagnetic inductive system with multi-signals can identify the function, which said another pointing device stands for, by gauging the frequency variation of said electromagnetic signals emitted from said pointing device or by identifying resonance frequency of said electromagnetic signals emitted from said pointing device.
